(19) United States
(12) Patent Application Publication
(10) Pub. No.: US 2007/0231028 A1
(43) Pub. Date: Oct. 4, 2007

(54) Fusing roller for image forming apparatus and image forming apparatus having the same

(75) Inventors: Seung-jun Lee, Suwon-si (KR); Dong-jin Seol, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/594,885

(22) Filed: Nov. 9, 2006

(30) Foreign Application Priority Data
Mar. 30, 2006 (KR) 10-2006-0029070

(51) Int. Cl. G03G 15/20

(52) U.S. Cl. 399/333

(57) ABSTRACT

A fusing roller for an image forming apparatus is provided. The fusing roller includes a tubular fusing unit having a treated surface, an inner pipe inserted into the fusing unit, a heating unit surrounding an outer circumferential surface of the inner pipe and generating heat, and an insulating unit. The insulating unit includes a first insulating unit, which includes one or more insulating layers and is disposed between the heating unit and the inner pipe, and a second insulating unit, which includes one or more insulating layers and is disposed between the heating unit and the fusing unit.

### CROSS-REFERENCE TO RELATED PATENT APPLICATION

This application claims the benefit under 35 U.S.C. §119(a) of Korean Patent Application No. 10-2006-0029070, filed on Mar. 30, 2006, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to an image forming apparatus having a fusing roller that fuses a toner image on a print medium by applying heat and pressure to the toner image.

2. Description of the Related Art

In general, electrophotographic image forming apparatuses form an electrostatic latent image, which corresponds to an image to be printed, on a photosensitive drum, develop the electrostatic latent image formed on the photosensitive drum using a toner, and transfer the developed toner image onto a print medium. The transferred tone image is then fixed onto a print medium by a fusing device that fuses the transferred toner image by applying heat and pressure to the toner image.

Conventional fusing devices include a fusing roller generating heat, and a pressure roller that faces the fusing roller and presses a print medium, onto which a toner image is transferred, against the fusing roller. There are various types of fusing rollers that use different methods of generating heat.

FIG. 1 is a vertical cross-sectional view of a conventional fusing device 10 of an image forming apparatus. The illustrated fusing device uses a halogen lamp as a heat source.

Referring to FIG. 1, the fusing device 10 includes a fusing roller 11 and a pressure roller 15. The fusing roller 11 includes a tubular fusing unit 12 and a heating unit 14, for example, a halogen lamp, installed at the center of the fusing unit 12. A release layer 13 made of, for example, polytetrafluoroethylene is coated on an outer circumferential surface of the fusing roller 11 so that a toner image 18 can be smoothly separated from a print medium 17. Heat generated by the heating unit 14 is radiated to the fusing unit 12 and transferred to an outer circumferential surface of the fusing unit 12, thereby increasing the temperature of the fusing device 10 to a fusing temperature.

The pressure roller 15 disposed under the fusing roller 11 contacts and presses the print medium 17 toward the fusing roller 11 when the print medium 17 passes between the rollers. Since the pressure roller 15 is elastically biased by elastic means 16 toward the fusing roller 11, the print medium 17 passing between the pressure roller 15 and the fusing roller 11 is pressed between the rollers. Accordingly, the toner image 18 transferred to the print medium 17 is fused on the print medium 17 due to the heat transferred from the heating unit 14 and the pressure applied by the pressure roller 15.

A conventional fusing device 10 using a halogen lamp as a heat source causes unnecessary power consumption. Thus, when there is no print job, the conventional fusing device 10 saves power by turning off the lamp, which makes the roller cool off. When the conventional fusing device 10 is turned off and then turned on to form an image, a relatively long warm-up time is required.

After power is applied to the fusing device 10, the fusing device 10 remains in a waiting state for a predetermined amount of time, that is, a first-print-out-time (FPOT), until it reaches a desired fusing temperature. This operation might take from several tens of seconds to several minutes. In particular, since the fusing roller 11 is heated by heat radiated from the heat source, the conventional fusing device 10 has a low heat transfer rate. Furthermore, the low heat transfer rate makes its difficult to compensate for the decrease in temperature that occurs due to contact with the print medium 17. Therefore, the conventional fusing device 10 cannot easily adjust temperature deviations.

Also, even when the image forming apparatus is in a standby mode in which printing operations are paused, power must be supplied at predetermined time intervals to the heat source to maintain the temperature of the fusing roller 11 at a constant level. Thus, unnecessary power consumption occurs. Moreover, since it takes a relatively long time to change from a standby mode to an operation mode to output an image, the conventional fusing device 10 cannot quickly output an image.

To address the above problems, attempts have been made to allow the heating unit to contact the fusing roller and thus directly transfer heat generated by the heating unit to the fusing roller. In this case, an electrical insulator is disposed between the heating unit, to which power is supplied, and the fusing roller. However, the electrical insulator may reduce the heat transfer efficiency of the heating unit. Accordingly, the electrical insulator should be thin and made of a material having high heat transfer efficiency and high dielectic strength.

Accordingly, there is a need for an improved fusing roller for an image forming apparatus that has an improved heat transfer efficiency.

### SUMMARY OF THE INVENTION

An aspect of the present invention is to address at least the above problems and/or disadvantages and to provide at least the advantages described below. Accordingly, an aspect of the present invention is to provide a fusing roller for an image forming apparatus, which is thin to improve heat transfer efficiency and reduce warm-up time, and includes an insulating unit to avoid electric leakage.

According to an aspect of the present invention, a fusing roller for an image forming apparatus is provided. The fusing roller includes a tubular fusing unit having a treated surface, an inner pipe inserted into the fusing unit, a heating unit surrounding an outer circumferential surface of the inner pipe and generating heat, and an insulating unit. The insulating unit includes a first insulating unit, which includes one or more insulating layers and is disposed between the heating unit and the inner pipe, and a second insulating unit, which includes one or more insulating layers and is disposed between the heating unit and the fusing unit.

According to another aspect of the present invention, a fusing roller for an image forming apparatus is provided. The fusing roller includes a tubular fusing unit, an inner pipe inserted into the fusing unit, a heating unit surrounding an outer circumferential surface of the inner pipe and generating heat, and an insulating unit. The insulating unit includes a first insulating unit, which includes one or more insulating layers and is disposed between the heating unit and the inner pipe, and a second insulating unit, which includes one or more insulating layers and is disposed between the heating unit and the fusing unit.

According to another aspect of the present invention, an image forming apparatus comprises a main body and a paper cassette disposed in the main body. The paper cassette holds a stack of printing paper. A pickup roller picks up a sheet of printing paper from the stack of printing paper and conveys the sheet of paper along a paper path. A developing device develops a toner image onto the conveyed sheet of paper. A fusing device including a fusing roller and a pressure roller biased towards the fusing roller fuses the developed toner image onto the sheet of paper. The fusing roller includes a tubular fusing unit having a treated surface, an inner pipe inserted into the fusing unit, a heating unit surrounding an outer circumferential surface of the inner pipe that generates heat, and an insulating unit. The insulating unit includes a first insulating unit, which includes one or more insulating layers and is disposed between the heating unit and the inner pipe, and a second insulating unit, which includes one or more insulating layers and is disposed between the heating unit and the fusing unit. A paper discharge unit discharges the sheet of paper with the fused toner image outside the main body.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a vertical cross-sectional view of a conventional fusing device, which uses a halogen lamp as a heat source, of an image forming apparatus;

FIG. 2 is a vertical cross-sectional view of a fusing device, which includes a fusing roller, of an image forming apparatus according to an exemplary embodiment of the present invention;

FIG. 3 is a horizontal cross-sectional view of the fusing roller of FIG. 2;

FIG. 4 is a partial enlarged view of portion A of FIG. 3

FIG. 5 is a partial enlarged view of a fusing roller according to another exemplary embodiment of the present invention;

FIG. 6 is a partial enlarged view of a fusing roller according to still another exemplary embodiment of the present invention;

FIG. 7 is a partial enlarged view of a fusing roller according to yet another exemplary embodiment of the present invention; and

FIG. 8 is a side view of the structure of an image forming apparatus utilizing a fusing device according to an exemplary embodiment of the present invention.

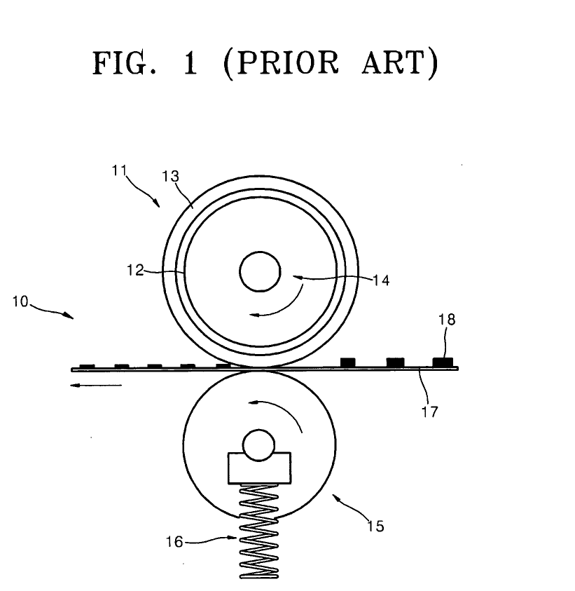

Throughout the drawings, the same reference numerals will be understood to refer to the same elements, features, and structures.

### DETAILED DESCRIPTION OF THE INVENTION

The matters defined in the description such as a detailed construction and elements are provided to assist in a comprehensive understanding of the exemplary embodiments of the invention and are merely exemplary. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

The present invention will now be described more fully with reference to the accompanying drawings, in which exemplary embodiments of the invention are shown.

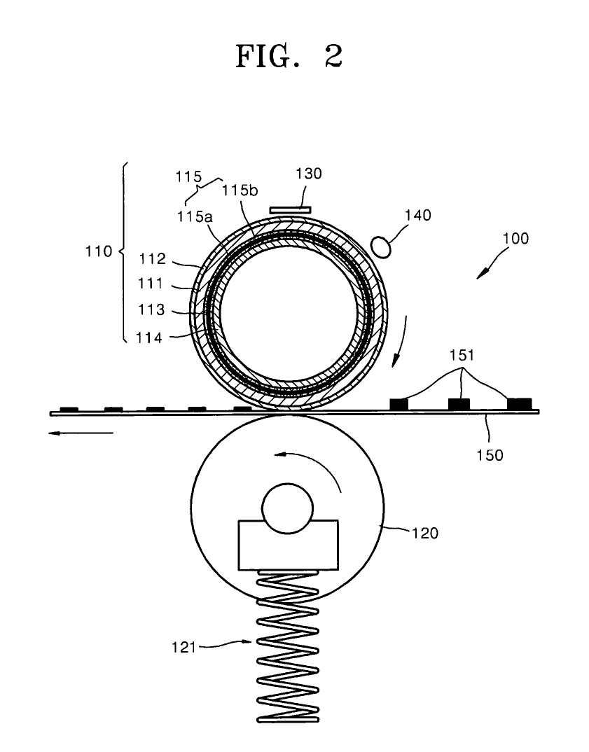

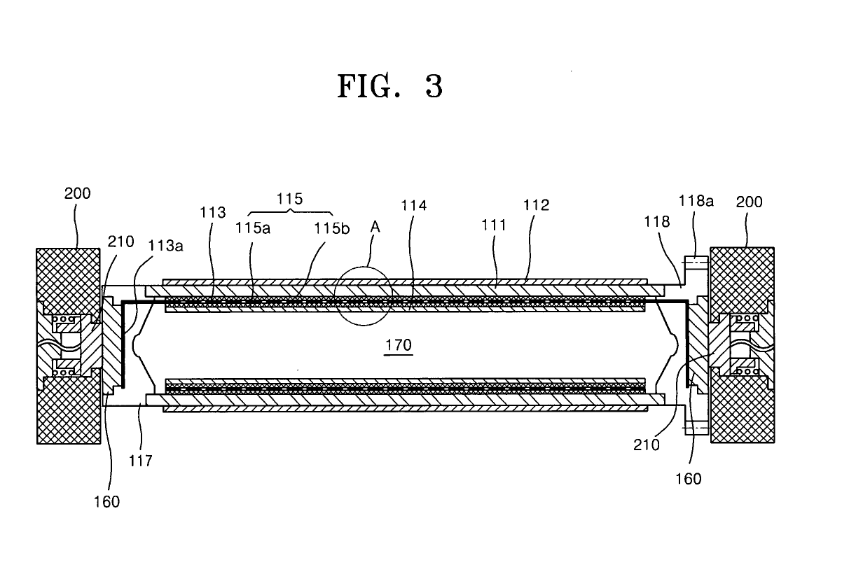

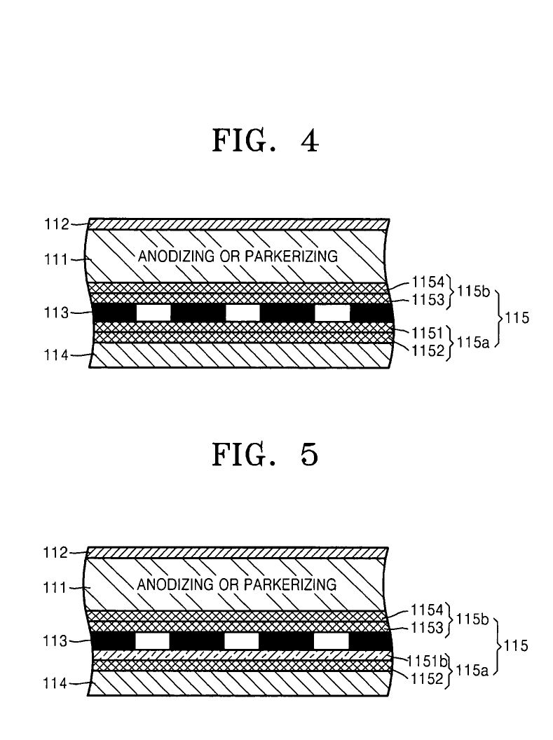

FIG. 2 is a vertical cross-sectional view of a fusing device, which includes a fusing roller, of an image forming apparatus according to an exemplary embodiment of the present invention. FIG. 3 is a horizontal cross-sectional view of the fusing roller of FIG. 2. FIG. 4 is a partial enlarged view of portion A of FIG. 3.

Referring to FIGS. 2 through 4, a fusing device 100 fuses a toner image 151 on a print medium 150 by applying heat and pressure to the toner image 151. The fusing device 100 includes a fusing roller 110 applying heat to the toner image 151 while rotating clockwise, and a pressure roller 120 facing the fusing roller 110 and elastically biased toward the fusing roller 110 by elastic means 121. The print medium 150 to which the toner image 151 is transferred is heated and pressed while passing between the fusing roller 110 and the pressure roller 120, such that the toner image 151 is fused on the print medium 150.

The fusing roller 110 includes a tubular fusing unit 111, an inner pipe 114 inserted into the fusing unit 111, a heating unit 113, and an insulating unit 115 that electrically insulates the heating unit 113.

The fusing unit 111 is open at both ends, and a release layer 112 made of polytetrafluoroethylene or the like is coated on an outer circumferential surface of the fusing unit 111 so that the print medium 150 and the toner image 151 can be smoothly separated from each other. The fusing unit 111 may be made of aluminium (Al) or steel. An end-cap 117 and a power transmission end-cap 118 are respectively inserted into both the ends of the fusing unit 111. The power transmission end-cap 118 is similar in structure to the end-cap 117, but includes a power transmission means 118a that is connected to a driving device (not shown) and rotates after receiving power. Electrodes 160 are respectively installed on the end-cap 117 and the power transmission end-cap 118. Current is applied to the electrodes 160 by contacting power supply units 210 that are elastically supported by frames 200. Accordingly, even while the fusing roller 110 rotates, the electrodes 160 are kept in contact with the power supply units 210 to receive current.

An inner space 170 of the fusing roller 110 is almost hermetically sealed by inserting the end-cap 117 and the power transmission end-cap 118 into both the ends of the fusing unit 111. Accordingly, heat generated by the heating unit 113 is transferred to the inner space 170 to increase the temperature of air in the inner space 170, thereby rapidly achieving an even temperature distribution in a longitudinal direction of the fusing roller 110.

The inner pipe 114 presses and supports the heating unit 113 so that the heating unit 113 can be adhered to the fusing unit 111, and is open at both ends. The inner pipe 114 may be made of aluminium (Al) or steel.

The heating unit 113 is disposed between the fusing unit 111 and the inner pipe 114, and includes resistance heating elements that radially surround an outer circumferential surface of the inner pipe 114 and receive current from an external power source. Lead units 113a are disposed on both ends of the heating unit 113 to receive current from the external power source. The lead units 113a are electrically connected to the electrodes 160. Accordingly, current input from the external power source can be supplied to the heating unit 113. Although the resistance heating elements of the heating unit 113 are spaced apart from one another in FIGS. 3 and 4 for convenience of explanation, the insulating unit 115 may be placed between the resistance heating elements since the resistance heating elements are thin.

The insulating unit 115 includes a first insulating unit 115a disposed between the heating unit 113 and the inner pipe 114 and a second insulating unit 115b disposed between the heating unit 113 and the fusing unit 111 as shown in FIG. 4.

The first insulating unit 115a includes a stack of two insulating layers 1151 and 1152, and the second insulating unit 115b includes a stack of two insulating layers 1153 and 1154. The first insulating unit 115a and the second insulating unit 115b may be made of polyimide.

Polyimide is a polymer that has a superior withstand voltage characteristic and a high resistance to dielectric breakdown, and it ensures high heat transfer efficiency since it can be made thin. However, polyimide may be carbonized if an arc occurs and, the carbon (C) component of the carbonized polyimide may conduct electricity, thereby causing electric leakage. Hence, separate insulating means for preventing electricity conducted by carbonized polyimide from leaking out of the fusing unit 111 is necessary. Each of the insulating layers 1151, 1152, 1153, and 1154 may have a thickness of 50 μm.

To prevent electric leakage from the fusing unit 111, the surface of the fusing unit 111 may be insulated. That is, when the fusing unit 111 is made of aluminium (Al), the surface of the fusing unit 111 is anodized, and when the fusing unit 111 is made of steel, the surface of the fusing unit 111 is parkerized. Anodizing and the parkerizing are well-known processes, and thus a detailed explanation thereof will not be given.

Here, the withstand voltage characteristic means the ability of the material to withstand predetermined external power, and the resistance to dielectric breakdown means an opposition to dielectric breakdown without a leakage current exceeding 10 mA for 60 seconds at a maximum withstand voltage.

Since the electricity conducted by the carbonized polyimide may leak to the inner pipe 114 as well, the inner pipe 114 may be anodized or parkerized. However, since the risk of electric leakage toward the inner pipe 114 is less than the risk of the electric leakage toward the fusing unit 111, the inner pipe 114 may not be anodized or parkerized.

After the surface of the fusing unit 111 is anodized or parkerized, the release layer 112, which acts as a protective layer, may be formed on the outer circumferential surface of the fusing unit 111.

As a result, according to the present exemplary embodiment, since the first insulating unit 115a and the second insulating unit 115b of the insulating unit 115 are made of polyimide and the fusing unit 111 is anodized or parkerized, electric leakage can be prevented.

FIG. 5 is a partial enlarged view of a fusing roller according to another exemplary embodiment of the present invention. Referring to FIG. 5, the fusing roller 110 of FIG. 5 is structurally identical to the fusing roller 110 of FIG. 4 except for the structure of the first insulating unit 115a.

The first insulating unit 115a includes an insulating unit 151a made of mica, which contacts the heating unit 113, and an insulating layer 1152 made of polyimide, which is disposed between the insulating layer 1151a and the inner pipe 114. The mica may have a thickness of 0.11 t.

The insulating layer 1151a made of mica prevents electricity conducted by the carbonized polyimide from leaking toward the inner pipe 114. The anodized or parkerized fusing unit 111 prevents electricity conducted by the carbonized polyimide of the second insulating unit 115 from leaking out through the fusing unit 111.

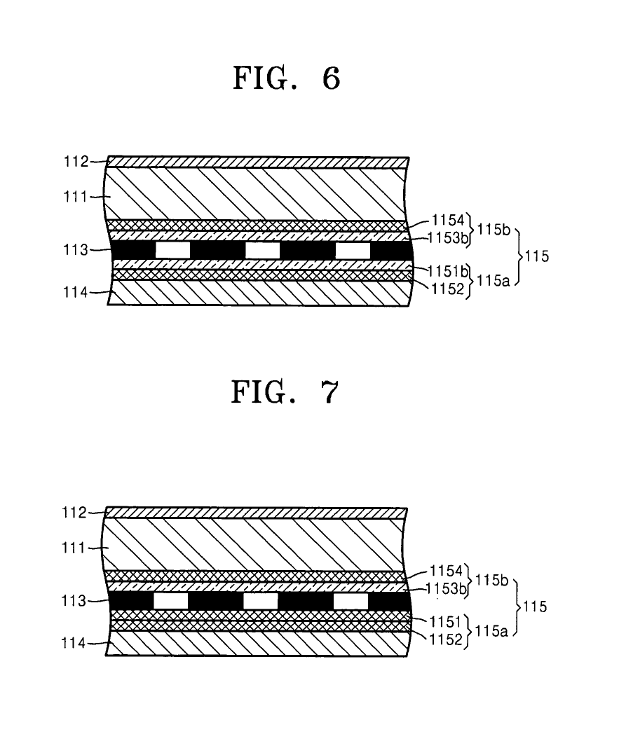

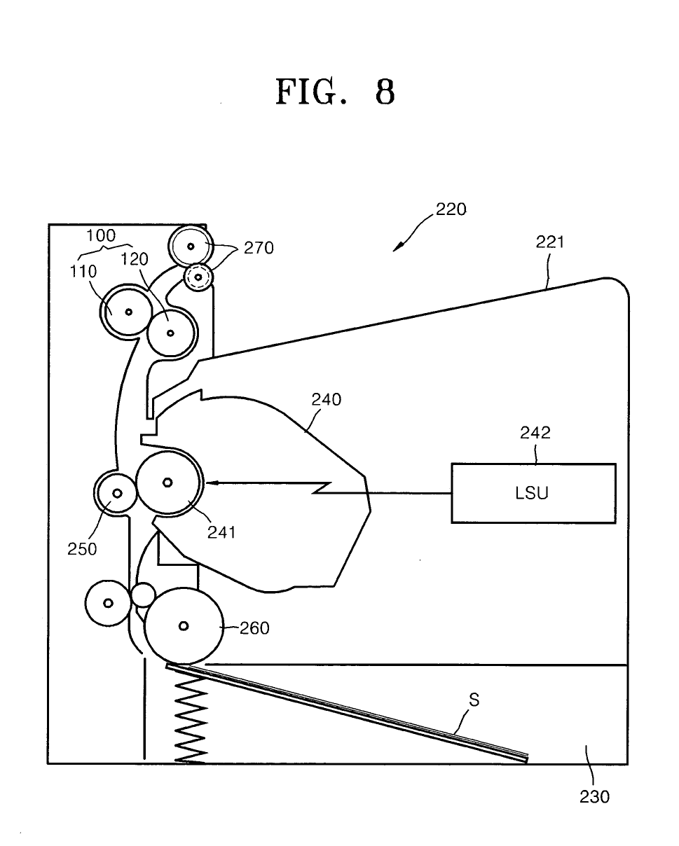

FIG. 6 is a partial enlarged view of a fusing roller according to still another exemplary embodiment of the present invention. FIG. 7 is a partial enlarged view of a fusing roller according to yet another exemplary embodiment of the present invention.

Referring to FIG. 6, the fusing roller 110 is structurally identical to the fusing roller 110 of FIG. 4 except for the structures of the first insulting unit 115a and the second insulating unit 115b. The first insulating unit 115a includes an insulating layer 1151b made of mica, which contacts the heating unit 113, and an insulating layer 1152 made of polyimide, which contacts the inner pipe 114. The second insulating unit 115b includes an insulating layer 1153b made of mica, which contacts the heating unit 113, and an insulating layer 1154 made of polyimide, which contacts the fusing unit 111.

The insulating layers 151b and 1153b made of mica surround the heating unit 113 and prevent electricity conducted by carbonized polyimide from leaking toward the fusing unit 111 and the inner pipe 114, thereby making it unnecessary to anodize or parkerize the fusing unit 111.

That is, since each of the first insulating unit 115a and the second insulating unit 115b includes the insulating layers made of mica and polyimide, the heat transfer efficiency can be improved and the thickness of an insulating unit 115 can be reduced.

Referring to FIG. 7, the fusing roller 110 is structurally identical to the fusing roller 110 of FIG. 4 except that the first insulating unit 115a is made of only polyimide.

The fusing roller 110 of FIG. 7 is structured in this way because the risk of electric leakage toward the inner pipe 114 due to the carbonized polyimide is less than the risk of electric leakage toward the fusing unit 111. The inner pipe 114 may be anodized or parkerized.

A thermostat 130 that prevents overheating by cutting off the power supply when the surface temperature of the fusing unit 111 increases sharply, and a thermistor 140 that measures the surface temperature of the fusing unit 111 are installed over the fusing roller 110.

A method of manufacturing the fusing roller 110 will now be explained. The first insulating unit 115a is installed on the outer circumferential surface of the inner pipe 114. The heating unit 113 radially surrounds the first insulating unit 115a. Next, the second insulating unit 115a surrounds the heating unit 113.

The inner pipe 114, on which the heating unit 113, the first insulating unit 115a, and the second insulating unit 115b are disposed, is inserted into the fusing unit 111.

Next, both the ends of the inner pipe 114 are closed and a predetermined pressure is applied into the inner space 170 to expand the inner pipe 114. The applied pressure may be, for example, greater than 140 millibars.

When the inner pipe 114 is expanded, the heating unit 113, the first insulating unit 115a, and the second insulating unit 115b adhere to an inner surface of the fusing unit 111. Since the heating unit 113 includes the resistance heating elements, the first insulating unit 115a and the second insulating unit 115b are placed between adjacent resistance heating elements.

The expansion of the inner pipe 114 can take place if the inner pipe 114 is made of a soft material such as aluminium. If the inner pipe 114 is made of a material such as steel, the inner pipe 114 on which the heating unit 113, the first insulating unit 115a, and the second insulating unit 115b are disposed is inserted into the fusing unit 111.

FIG. 8 is a side view of the structure of an image forming apparatus utilizing a fusing device according to an exemplary embodiment of the present invention.

Referring to FIG. 8, the image forming apparatus 220 has a paper cassette 230, on which printing media, such as sheets of paper S, are loaded. The paper cassette 230 may be attachable to and detachable from the image forming apparatus 220, and may be installed under the main body 221 of the image forming apparatus 220. A pickup roller 260 picks up the printing media S sheet by sheet and is installed on the paper cassette 230.

The image forming apparatus 220 includes a developing device 240, an exposure device 242, a transfer roller 250, the fusing device 100, and a paper discharge unit 270. Each component is disposed along a transfer path of the print paper S.

The developing device 240 supplies toner as a developing agent to an electrostatic latent image formed on a photosensitive medium to develop a toner image. The developing device 240 may be removable from the main body 221. The developing device 240 comprises a photosensitive drum 241 that has a portion exposed to the outside.

The exposure device 242 forms an electrostatic latent image on the surface of the photosensitive drum 241 in response to print data. The exposure device 242 is typically a laser scanning unit (LSU) that radiates light generated by a light source on the surface of the photosensitive drum 241.

The transfer roller 250 is installed to face the photosensitive drum 241. The transfer roller 250 transfers the toner image formed on the photosensitive drum 241 to the print paper S.

As described in detail above, the fusing device 100 fuses the toner image on the print paper S by heat and pressure, and comprises a fusing roller 110 and pressure roller 120.

As described above, the fusing roller of the image forming apparatus according to the present invention has the following advantages.

First, since the insulating unit 115 is made of only polyimide or a mixture of polyimide and mica, the thickness of the insulating unit 115 can be reduced, thereby improving heat transfer efficiency through the insulating unit 115 and reducing warm-up time.

Second, since the fusing unit 111 or the inner pipe 114 is anodized or parkerized, electricity conducted by carbonized polyimide is prevented from leaking toward the fusing unit 111 or the inner pipe 114.

Third, since inexpensive polyimide is used, the total manufacturing costs of the fusing roller can be reduced.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A fusing roller for an image forming apparatus, the fusing roller comprising:
a tubular fusing unit having a treated surface;
an inner pipe inserted into the fusing unit;
a heating unit surrounding an outer circumferential surface of the inner pipe that generates heat; and
an insulating unit including a first insulating unit, which includes one or more insulating layers and is disposed between the heating unit and the inner pipe, and a second insulating unit, which includes one or more insulating layers and is disposed between the heating unit and the fusing unit.

2. The fusing roller of claim 1, wherein the fusing unit is made of aluminium, and the surface of the fusing unit is anodized.

3. The fusing roller of claim 2, wherein each of the first insulating unit and the second insulating unit comprises polyimide.

4. The fusing roller of claim 3, wherein the first insulating unit further includes an insulating unit made of mica, which contacts the heating unit.

5. The fusing roller of claim 1, wherein the fusing unit is made of steel, and the surface of the fusing unit is parkerized.

6. The fusing roller of claim 5, wherein each of the first insulating unit and the second insulating unit comprises polyimide.

7. The fusing roller of claim 6, wherein the first insulating unit further includes an insulating unit made of mica, which contacts the heating unit.

8. A fusing roller for an image forming apparatus, the fusing roller comprising:
a tubular fusing unit;
an inner pipe inserted into the fusing unit;
a heating unit surrounding an outer circumferential surface of the inner pipe and generating heat; and
an insulating unit including a first insulating unit, which includes one or more insulating layers and is disposed between the heating unit and the inner pipe, and a second insulating unit, which includes one or more insulating layers and is disposed between the heating unit and the fusing unit.

9. The fusing roller of claim 8, wherein each of the first insulating unit and the second insulating unit comprises polyimide.

10. The fusing roller of claim 8, wherein the first insulating unit further includes an insulating unit made of mica, which contacts the heating unit.

11. The fusing roller of claim 10, wherein the second insulating unit further includes an insulating unit made of mica, which contacts the heating unit.

12. The fusing roller of claim 9, wherein the second insulating unit further includes an insulating unit made of mica, which contacts the heating unit.

13. A fusing device for an image forming apparatus, comprising:
a fusing roller; and
a pressure roller biased towards the fusing roller,
wherein the fusing roller comprises:
a tubular fusing unit;
an inner pipe inserted into the fusing unit;
a heating unit; and
an insulating unit that electrically insulates the heating unit, the insulating unit a first insulating unit with one or more insulating layers disposed between the heating unit and the inner pipe, and a second insulating unit with one or more insulating layers disposed between the heating unit and the fusing unit.

14. The fusing device of claim 13, wherein the first and second insulating units comprise polyimide.

15. The fusing device of claim 13, wherein the fusing unit is made of aluminium, and the surface of the fusing unit is anodized.

16. The fusing device of claim 15, wherein each of the first insulating unit and the second insulating unit comprises polyimide.

17. The fusing device of claim 16, wherein the first insulating unit further includes an insulating unit made of mica, which contacts the heating unit.

18. The fusing device of claim 13, wherein the fusing unit is made of steel, and the surface of the fusing unit is parkerized.

19. The fusing device of claim 18, wherein the first and second insulating units comprise polyimide.

20. The fusing device of claim 19, wherein the first insulating unit further includes an insulating unit made of mica, which contacts the heating unit.

21. An image forming apparatus comprising:
a main body;
a paper cassette disposed in the main body, the paper cassette holding a stack of printing paper;
a pickup roller for picking up a sheet of printing paper from the stack of printing paper and conveying the sheet of paper along a paper path;
a developing device for developing a toner image onto the conveyed sheet of paper;
a fusing device including a fusing roller and a pressure roller biased towards the fusing roller for fusing the developed toner image onto the sheet of paper; the fusing roller comprising:
a tubular fusing unit having a treated surface;
an inner pipe inserted into the fusing unit;
a heating unit surrounding an outer circumferential surface of the inner pipe that generates heat; and
an insulating unit including a first insulating unit, which includes one or more insulating layers and is disposed between the heating unit and the inner pipe, and a second insulating unit, which includes one or more insulating layers and is disposed between the heating unit and the fusing unit; and
a paper discharge unit for discharging the sheet of paper with the fused toner image outside the main body.

22. The image forming apparatus of claim 21, wherein the fusing unit is made of aluminium, and the surface of the fusing unit is anodized.

23. The image forming apparatus of claim 22, wherein each of the first insulating unit and the second insulating unit comprises polyimide.

24. The image forming apparatus of claim 23, wherein the first insulating unit further includes an insulating unit made of mica, which contacts the heating unit.

25. The image forming apparatus of claim 21, wherein the fusing unit is made of steel, and the surface of the fusing unit is parkerized.

26. The image forming apparatus of claim 25, wherein each of the first insulating unit and the second insulating unit comprises polyimide.
